(19) United States
(12) Patent Application Publication
(10) Pub. No.: US 2001/0001623 A1
(43) Pub. Date: May 24, 2001

(54) OPTICAL FIBER SPLICE DEVICE

(76) Inventors: KATSUMI INADA, OTSU-SHI (JP); HIROKAZU TAKEUCHI, OTSU-SHI (JP); YOSHIMASA YAMAGUCHI, OTSU-SHI (JP); TAKASHI TSUNEOKA, OTSU-SHI (JP); TAKERU OTOBA, HIGASHIOSAKA-SHI (JP); TAKAHIRO ABE, HIGASHIOSAKA-SHI (JP); YUTAKA TANAKA, HIGASHIOSAKA-SHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/227,733

(22) Filed: Jan. 8, 1999

(51) Int. Cl. G02B 6/255

(52) U.S. Cl. 385/99

(57) ABSTRACT

An optical fiber splice device in which an optical fiber can be connected to a branch line side thereof as the need arises such as in the case where new subscribers join after a multiple optical fiber is connected to a trunk line side thereof. The device includes a plurality of glass capillary tubes, a body equipped with the plurality of glass capillary tubes in a middle portion thereof and a cover glass covering and protecting at least the region where the plurality of glass capillary tubes are provided. The ends of optical fibers of the trunk and branch lines are inserted in the glass capillary tubes to be spliced therein. The optical fiber ends has the coatings thereof removed. The body includes a mount portion in the middle thereof where the plurality of capillary tubes are provided in parallel, and first and second fixing portions on both sides of the mount portion for guiding and fixing the optical fibers to the glass capillary tubes. The first fixing portion is formed so that all of a plurality of optical fibers of a trunk line can be fixed after being respectively inserted in the plurality of glass capillary tubes. The second fixing portion has guide grooves for guiding optical fibers of branch lines to the plurality of glass capillary tubes respectively.

### BACKGROUND OF THE INVENTION

1. Field of the Invention

The present invention relates to an optical fiber splice device.

2. Description of the Related Art

For example, during constructing a subscriber type optical fiber network which allows telephone offices and the like of communication service providers and each subscriber to communicate with each other, an enormous number of optical fiber cables are required since the number of optical fibers corresponding to a number of the subscriber is required. Under such circumstances, in order to increase the density of communication lines, ribbon-like optical fibers formed by bundling a plurality of optical fibers in parallel (multiple optical fibers) are used for trunk lines at telephone offices and the like.

Dividing and leading multiple optical fibers from a trunk line to each subscriber is carried out as follows. Firstly, an end of the trunk line side optical fiber cable is divided into single or multiple optical fibers, then the divided optical fibers are spliced with branch line side optical fibers respectively.

There are two types of known conventional optical fiber splice devices, one being a device for splicing between single optical fibers and other a device for splicing between multiple optical fibers. Both of them have been constructed so that optical fibers of the trunk and branch lines can be connected to an optical fiber splice device simultaneously. In addition, a trunk line side and a branch line side of each splice device are in a symmetrical configuration.

In the subscriber type optical fiber network as described above, it has become necessary for the branch line side optical fibers to be connected to the splice device as the need later arises such as in the case where new subscribers join the system.

However, conventional optical fiber splice devices have been developed so that optical fibers of the trunk and branch lines can be connected to an optical fiber splice device simultaneously as described above. Therefore, conventional optical fiber splice devices do not allow the branch line side optical fibers to be connected to them as the need later arises after all of trunk line side optical fibers are simultaneously connected to the optical fiber splice devices.

One problem arises as described below since there is no provision to allow the branch line side optical fibers to be connected to the splice device as the need arises such a case that new subscribers join after the trunk line side multiple optical fibers are connected to the splice device as described above. The use of an adhesive or a means of fixing spliced optical fibers becomes an obstacle which makes it impossible or very difficult to be connected the new branch line side optical fibers to the splice device.

Further, another problem arises as described below since the trunk line side and branch line side of the splice device are in a symmetrical configuration. Optical fibers of trunk and branch lines can not be spliced with each other when the optical fibers of the trunk and branch lines have different outer diameters of their coatings.

### SUMMARY OF THE INVENTION

The present invention proposes taking the above-described problems with conventional optical fiber splice devices into consideration, and it is an object of the invention to provide an optical fiber splice device in which an optical fiber can be connected to a branch line side thereof as the need arises such as in the case where a new subscriber joins after a multiple optical fiber is connected to a trunk line side thereof. It is another object of the invention to provide an optical fiber splice device which involves simple splicing operations and which is easy to handle.

In order to achieve the above-described objects, the present invention comprises a plurality of glass capillary tubes, a body equipped with the plurality of glass capillary tubes in the middle thereof and a cover glass for covering and protecting at least the region where the plurality of glass capillary tubes are provided. The ends of optical fibers of trunk and branch lines are inserted in the glass capillary tubes to be spliced therein. The optical fiber ends have their coatings removed.

The body includes a mount portion in the middle thereof where the plurality of capillary tubes are provided in parallel, and first and second fixing portions on both sides of the mount portion for guiding and fixing the optical fibers to the glass capillary tubes.

The first fixing portion is formed so that all of a plurality of optical fibers of a trunk line can be fixed after they are respectively inserted in the plurality of glass capillary tubes.

The second fixing portion has guide grooves for guiding optical fibers of branch lines to the plurality of glass capillary tubes, respectively. Further, the second fixing portion is formed so as to allow a required number of optical fibers of the branch lines to be spliced to respective optical fibers of the trunk line and fixed there with an adhesive after they are guided into the glass capillary tubes through the guide grooves when the need arises.

The cover glass is mounted on and fixed to the body in order to cover and protect the mount portion and the first and second fixing portions.

The above-described construction of the optical fiber splice device according to the invention allows reliable and easy insertion of the optical fibers of the branch lines into the glass capillary tubes using the guide grooves.

The cover glass protects the glass capillary tubes and the fixed optical fibers, together with the body. Integration of the cover glass and the body prevents the parts from being dropped, damaged or from being lost, and facilitates the handling of the same since it is not necessary to take the cover glass off the body at the time of splicing additional optical fibers of the branch lines later. This consequently improves the efficiency of splicing operations.

Each of the guide grooves formed on the body for the branch line is defined by a substantially rectangular bottom plate, side walls being formed on the bottom plate at both sides thereof and a partition walls being provided in parallel with the side walls to partition a space between the side walls. The partition walls provided between the guide grooves are formed so as to prevent an adhesive injected into a guide groove from flowing into other guide grooves adjacent thereto.

The optical fibers of the branch lines are fixed by injecting adhesive into the guide grooves. The an adhesive injected into the guide groove will not flow into the adjacent guide grooves since the partition walls are provided between the guide grooves. Therefore, the optical fiber splice device according to the present invention enables additional optical fibers of branch lines to be spliced later and arbitrarily.

The guide grooves for the branch line are formed on the body with such a diameter as be adapted to the outer diameter of the coatings of the branch line side optical fibers. In addition, the guide groove includes a tapered or flared portion for guiding an optical fiber from the guide groove toward the glass capillary tube.

The above-described construction enables branch line side optical fibers having various outer diameters of the coatings to be spliced. The tapered guide surfaces provided at the farther ends of the guide grooves allow branch line side optical fibers to be accurately guided toward the centers of the glass capillary tubes then inserted thereto even if the branch line side optical fibers have various outer diameters of the coatings. Thus, the splicing operation is simplified.

Preferably, the cover glass has a smaller length than the body and is mounted and secured to the body so that openings are defined at both ends of the body in order to facilitate the injection of fixing adhesive. Preferably, a transparent plate glass is used as the cover glass so as to allow the state of splicing to be observed from the outside. Further, a photo-curing adhesive is preferably used so that the adhesive can be cured by irradiation of light such as ultraviolet light transmitted from above through the cover glass. If the adhesive has a refractive index substantially equal to that of the cores of optical fibers, the adhesive can be injected into the fixing portions before the optical fibers are inserted in the glass capillary tubes. For obtaining a stable splicing performance of the optical fiber splicing portions, branch line side optical fibers are preferably fixed to the body with the ends of the coatings by the adhesive. Further, the glass capillary tubes preferably include slots for introducing an index-matching material substantially in the middle thereof. The index-matching material is preferably introduced into the glass capillary tubes in advance. In order to prevent mistakes in splicing operations, identification marks are preferably provided in the vicinity of both ends of the body for identifying the first fixing portion of the trunk line side and the second fixing portion of the branch line side.

Furthermore, in an optical fiber splice device according to the invention, cover members are removably provided on both sides of the body.

The cover members prevent the optical fibers fixed in the splice device from being excessively loaded with a bending force during a splicing operation of additional branch line side optical fibers. Also, the cover members prevent foreign substances from entering the splicing portions, the glass capillary tubes and guide grooves in which additional branch line side optical fibers will be later spliced.

### BRIEF DESCRIPTION OF THE DRAWINGS

Various other objects, features and attendant advantages of the present invention will be more fully appreciated as the same becomes better understood from the following detailed description when considered in connection with the accompanying drawings in which like reference characters designate like or corresponding parts throughout the several views and wherein:

FIGS. 1A and 1B illustrate an embodiment of an optical fiber splice device according to the present invention wherever FIG. 1A is a partially cut-away perspective illustration, and FIG. 1B is a sectional view.

FIG. 2 is a longitudinal sectional side view of the optical fiber splice device according to the invention showing the state of splicing therein.

FIGS. 3A, 3B and 3C are illustrations showing the order of the splicing steps.

FIG. 4 illustrates a second embodiment of the invention.

### DESCRIPTION OF THE PREFERRED EMBODIMENTS

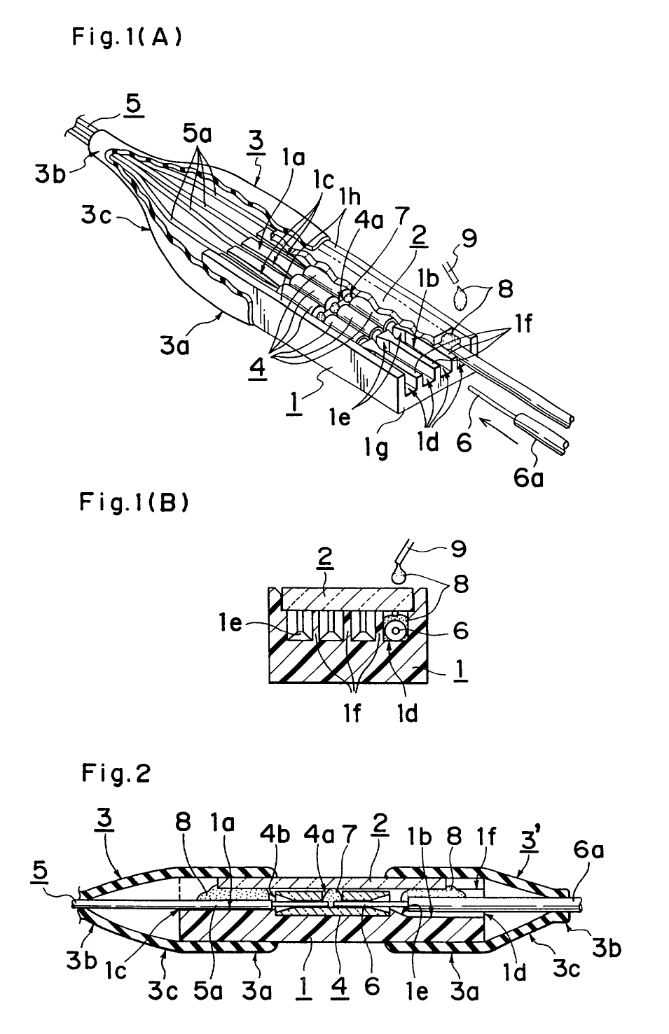

A first embodiment of the invention will now be described. FIGS. 1A and 1B illustrate an embodiment of an optical fiber splice device according to the invention wherein: FIG. 1A is a partially cut-away perspective illustration, and FIG. 1B is a sectional view. FIG. 2 is a longitudinal sectional side view illustrating the splice of optical fibers using the optical fiber splice device according to the invention. In those figures, numeral 1 designates a body, numeral 2 designates a cover glass, numerals 3 and 3′ designate first and second rubber boots serving as cover members, numeral 4 designates glass capillary tubes, numeral 5 designates a multiple optical fiber of a trunk line, numeral 6 designates a single optical fiber of the branch line, numeral 7 designates an index matching material and numeral 8 designates an adhesive.

First, the construction of the optical fiber splice device according to the invention will be described.

The present embodiment refers to a body 1 made of resin, for example. The body 1 includes a mount portion in the middle thereof for mounting the glass capillary tubes 4 thereon and first and second fixing portions 1a and 1b on both sides thereof for guiding and fixing the optical fibers 5 and 6 to the glass capillary tubes 4.

A plurality of glass capillary tubes 4 are provided in the middle of the body 1 and such are parallel with one another. The first and second fixing portions 1a and 1b for the plurality of optical fibers 5 and 6 to be inserted in the respective glass capillary tubes 4 are provided on both sides of the plurality of glass capillary tubes 4. The peripheries of both ends of the body 1 are chamfered in order to facilitate the mounting of the first and second rubber boots 3 and 3′ to be described later.

The glass capillary tubes 4 are bonded and fixed in advance in the middle of the body 1 so as to be spaced apart by a constant pitch. Referring to their dimensions, for example, the outer diameter is 1.8 mm and the length is 14 mm. FIGS. 1A and 1B show a case wherein four glass capillary tubes 4 are spaced apart by a pitch of 1.8 mm. In this case, the general dimensions of the body 1 are, for example, 30 mm in length, 10 mm in width and 4 mm in height.

A slot 4a is provided in each glass capillary tube 4 for introducing the index-matching material 7. The index-matching material 7 has a refractive index substantially equal to that of the cores of the optical fibers.

In order to facilitate the operation of inserting the optical fibers 5 and 6 into the glass capillary tubes 4, the first and second fixing portions 1a and 1b respectively include first and second guide grooves 1c and 1d which extend between both ends of the glass capillary tubes 4 and both ends of the body 1. Both first and second guide grooves 1c and 1d are spaced apart by a constant pitch in conformity with the pitch between the glass capillary tubes 4. For example, when the glass capillary tubes 4 are spaced apart by a pitch of 1.8 mm, both first and second guide grooves 1c and 1d are also spaced apart by a pitch of 1.8 mm. The first guide grooves 1c comprise guide means for inserting optical fibers 5a of the multiple optical fiber 5 into the glass capillary tubes 4 simultaneously. The second guide grooves 1d comprise guide means for inserting single optical fibers 6 into the glass capillary tubes 4 respectively as the need arises.

The second guide grooves 1d are defined by a substantially rectangular bottom plate 1g, side walls 1h formed on the bottom plate 1g at both sides thereof and by partition walls 1f provided in parallel with the side walls 1h so as to partition a space between the side walls 1h. The partition walls 1f are formed so as to prevent the adhesive 8 injected into one second guide groove 1d from flowing into adjacent second guide grooves 1d.

Each second guide groove 1d is formed so as to accept the largest outer diameter of a coating 6a of a single optical fiber 6. For example, the outer diameter of the coating 6a of the single optical fiber 6 is in the range from about 0.25 mm to about 0.9 mm. Further, each second guide groove 1d is formed with a tapered guide surface 1e for guiding the optical fiber 6 toward the central hole 4b of glass capillary tube 4.

The cover glass 2 is bonded and secured to an upper surface of the body 1 in advance in order to cover and protect the mount portion for the glass capillary tubes 4, the first and second fixing portions 1a and 1b in the body 1. The body 1 is provided with step portions or notches (not shown) for positioning the cover glass 2. A transparent plate glass is preferably used as the cover glass 2 so as to allow the observation of the state of splice from the outside. Further, a photo-curing adhesive is preferably used as the adhesive 8 so that the adhesive 8 can be cured by irradiation of light such as ultraviolet light transmitted from above through the cover glass 2. A syringe 9 is preferably used as an adhesive injection means for bonding and fixing the optical fibers 5 and 6 to the body 1, glass capillary tubes 4 and cover glass 2. The syringe 9 enables the adhesive 8 to be accurately injected into a target point from a gap between the body 1 and cover glass 2. It also enables the amount of injection to be properly set without any excess or shortage. The cover glass 2 is made slightly shorter than the body 1 so as to secure gaps on both sides of the body 1 in order to facilitate the insertion of the optical fibers 5 and 6 and the injection of the adhesive 8. For example, when the body is 30 mm long, the length of the cover glass 2 is 26 mm.

The first and second rubber boots 3 and 3′ used as cover members are removably attached to the sides of the body 1. The first and second rubber boots 3 and 3′ cover and protect the optical fibers 5 and 6 which are spliced with each other in the glass capillary tubes 4 and extend from both sides of the body 1. They also cover and protect the glass capillary tubes 4 and first and second guide grooves 1c and 1d into which optical fibers 5, 6 are inserted later to be spliced to each other. The first and second rubber boots 3 and 3′ are made of a rubber material which is selected appropriately. The first and second rubber boots 3 and 3′ are molded so as to have the configuration defined by a larger diameter portion 3a, a smaller diameter portion 3b and a conical portion 3c formed between them.

The larger diameter portion 3a which receives the end of the body 1 has an inner diameter which is slightly smaller than the outer diameter of the end of the body 1. The smaller diameter portion 3b has an inner diameter which is converged to such a size so that the plurality of optical fibers 5 and 6 can be inserted therethrough with some clearance.

The first and second rubber boots 3 and 3′ are used in order to prevent the optical fibers fixed in the splice device from being excessively loaded with bending force during a splicing operation and the like. In addition, they are used in order to prevent foreign substances from entering to the optical fiber splicing portions, glass capillary tubes 4 and first and second guide grooves 1o and Id in which additional branch line side optical fibers will be inserted and later spliced.

An example of the utilization will now be described with a general description being made first. All of the optical fibers 5a divided from the trunk line side multiple optical fiber 5 are simultaneously inserted in the glass capillary tubes 4 respectively. The trunk line side optical fibers 5a are bonded and fixed to the body 1, glass capillary tubes 4 and cover glass 2 with the ultraviolet light-curing adhesive 8. Thereafter, branch line side single optical fibers 6 are respectively inserted into the related glass capillary tubes 4, then spliced to the related trunk line side optical fibers 5a when need arises. In addition, the branch line side single optical fibers 6 are bonded and fixed to the body 1, glass capillary tubes 4 and cover glass 2 with the adhesive 8.

As for further details, the end of the trunk line side ribbon-like multiple optical fiber 5 is inserted through the first rubber boot 3, then divided into a plurality of optical fibers 5a. End of each divided optical-fiber 5a has the coating thereon removed along a predetermined length thereof using a dedicated tool or the like. For example, the coating is removed by about the same length as half the length of the glass capillary tubes 4 using the dedicated tool or the like.

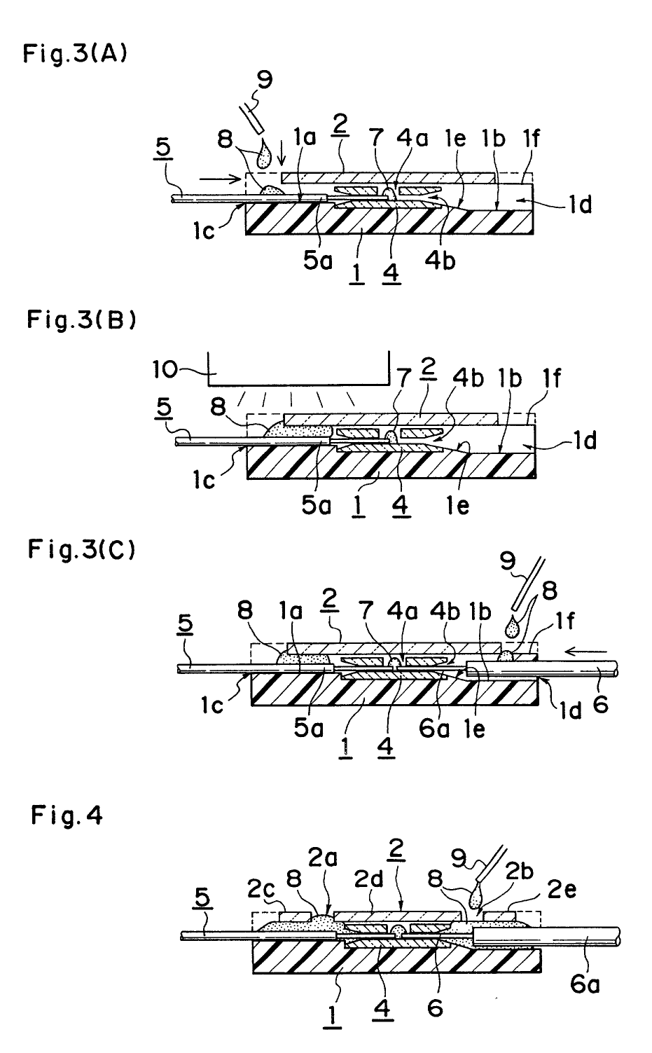

Next, as shown in FIG. 3A, the end of each divided optical fiber 5a is inserted up to the middle of the respective glass capillary tube 4 along the first guide groove 1c on the body 1. The insertion of the optical fibers 5a is carried out utilizing a visual check through the transparent cover glass 2. Thereafter, the adhesive 8 is injected through the gap between the first fixing portion 1a of the body 1 and the cover glass 2 using the syringe 9.

Further, as shown in FIG. 3B, the injected adhesive 8 is irradiated and cured with ultraviolet light from an ultraviolet lamp 10. Thus, each of the divided optical fibers 5a from the multiple optical fiber 5 is bonded and fixed to the body 1, glass capillary tube 4 and cover glass 2 on the side of the first fixing portion 1a of the body 1.

After the splicing operation concerning the divided optical fibers 5a has been finished, the first rubber boot 3 is fitted to the end of the body 1 on the side of the first fixing portion 1a.

Next, as shown in FIGS. 1A, 2 and 3C, the required number of branch line side single optical fibers 6 are spliced when the need arises.

The single optical fibers 6 are inserted through the second rubber boot 31 in advance. Coatings 6a are removed from the ends of the optical fibers 6 by a predetermined length using a dedicated tool or the like. For example, each coating 6a is removed by about the same length as is the half length of the glass capillary tubes 4 using the dedicated tool or the like. The glass capillary tube 4 is selected, in which the end of the trunk line side optical fiber 5a to be spliced has already been inserted and fixed.

The fiber end 6a having the coating removed is inserted up to the middle of the selected glass capillary tube 4 along the second guide grooves 1 d on the body 1. The end of the branch line side single optical fiber 6 and the end of the trunk line side optical fiber 5a meet in the glass capillary tube 4. At this time, even if there is any slight gap between the optical fibers 5a and 6, such will not cause any problems since the index matching material 7 has been introduced in the middle of the central holes 4b of the glass capillary tube 4 in advance.

Thus, the required number of single optical fibers 6 are respectively inserted in the related glass capillary tubes 4. When the insertion of the single optical fibers 6 is complete, an appropriate amount of the adhesive 8 is injected into the related second guide grooves 1d using the syringe 9.

Since the partition walls 1f are provided between the second guide grooves 1d, the adhesive 8 will never flow into other second guide grooves 1d adjacent thereto. After the adhesive 8 is injected, the adhesive 8 is irradiated with ultraviolet light from the ultraviolet lamp 10 as described above, then the adhesive 8 in the second guide grooves 1d is cured. Thus, the single optical fibers 6 are bonded and fixed to the body 1, the glass capillary tubes 4 and cover glass 2 on the side of the second fixing portion 1b of the body 1. The bonded regions of the single optical fibers 6 include the ends of the coatings 6a.

When the splicing operation of the single optical fibers is finished, the second rubber boot 3′ is fitted to the end of the body 1 on the side of the second fixing portion 1b.

Through the above-described steps, the required number of branch line side single optical fibers are spliced as the need arises.

As described above, the optical fiber splice device according to the invention enables additional branch line side optical fibers to be spliced later at any time. This simplifies splicing operations and allows easier handling.

Therefore, the splice device of the present invention is most suitable as a splice device between trunk line side optical fibers and branch line side optical fibers in constructing a subscriber type optical fiber network to connect telephone offices and each subscriber.

Further, the optical fiber splice device of the present invention is suitable for a case in which the ribbon-like multiple optical fiber 5 is divided so as to be spliced with the plurality of single optical fibers 6. Especially, it is suitable for a case in which all of the divided optical fibers 5a of the multiple optical fiber 5 are simultaneously inserted into the glass capillary tubes 4 and bonded and fixed to the body 1, glass capillary tubes 4 and cover glass 2, then, as the need arises, a required number of single optical fibers 6 are inserted into the glass capillary tubes 4, bonded and fixed to the body 1, glass capillary tubes 4 and cover glass 2.

The number of the ribbon-like multiple optical fiber 5 is not limited to a single fiber. A plurality of ribbon-like multiple optical fibers 5 may be provided in the first fixing portion 1a of the body 1 in parallel with each other. In this case, the partition walls 1f may be provided or omitted.

In the optical fiber splice device according to the present invention, the coatings on the optical fibers 5 and 6 are bonded and fixed to the body 1, glass capillary tubes 4 and cover glass 2 using the ultraviolet light-curing adhesive 8. This makes it possible to achieve a smaller size and a lower cost as compared to an optical fiber splice device having mechanical fixing means such as clamp means, and to improve the efficiency of splicing operations. The present invention is not limited to the use of the adhesive 8 as described above. For example, it is possible to use adhesive 8 including an index matching material having a refractive index substantially equal to that of the cores of optical fibers. In this case, the adhesive 8 may be injected before the optical fibers 5 and 6 are inserted in the glass capillary tubes 4.

In addition, the provision of marks to identify the trunk line side and branch line side on the body 1 will make it possible-to prevent mistakes during splicing operations. The optical fiber splice device according to the present invention may obviously be used for splicing between multiple optical fibers.

A splice test was conducted to check the performance of the optical fiber splice device according to the invention. Optical signals having wavelengths of 1.31 μm and 1.55 μm were used. Single-mode optical fibers having a diameter of 125 μm and a core diameter of 9 μm were used as optical fibers of the trunk line and branch lines.

The test resulted in an average splice loss of 0.2 dB or less and an average return loss of 60 dB or more. A temperature cycle test in the range from −30 to 70° C. had an excellent result in which the fluctuation of the optical signals was 0.2 dB or less.

A second embodiment of the invention will now be described. FIG. 4 shows the second embodiment of an optical fiber splice device according to the present invention. This embodiment is different from the first embodiment in terms of openings 2a and 2b being provided for injecting the adhesive.

The openings 2a and 2b for injecting the adhesive are provided in positions of the cover glass 2 corresponding to both ends of the glass capillary tubes 4. In this case, it is possible to use such a cover glass 2 as is a single sheet of glass having openings 2a and 2b thereon, or as are made up of three parts indicated by reference numbers 2c, 2d and 2e in FIG. 4.

Such a construction provides the following effect in addition to the effect provided by the optical fiber splice device according to the first embodiment.

The region of an optical fiber having the coating removed can be directly fixed to a glass capillary tube having a small expansion coefficient by using adhesive. Therefore, the influence of the expansion and contraction of the adhesive which has a greater expansion coefficient, is reduced. Further, the fluctuations occurring during a temperature cycle test concerning optical signals, is reduced. As a result, the stability and reliability of the splicing performance of an optical fiber splicing portion can be improved.

In addition, even if adhesive has a somewhat higher viscosity (lower fluidity), the adhesive can be easily injected into and distributed at a gap between the optical fiber, the body of the optical fiber splice device and the cover glass.

Although the present invention has been described in its preferred embodiments, it is to be understood that the invention is not limited thereto and that various changes and modifications may be made without departing from the spirit and scope of the invention.

1. An optical fiber splice device comprising:
a plurality of substantially parallel glass capillary tubes;
a body having said glass capillary tubes in the middle thereof; and
a cover glass covering at least a region where said glass capillary tubes are provided, wherein
each said glass capillary tubes has a bore formed therethrough for inserting end portions of optical fibers on the trunk line side and branch line side to be spliced therein;
said body includes a mount portion in a middle portion thereof where said capillary tubes are provided, and first and second fixing portions at both sides of said mount portion, said fixing portions guiding the optical fibers into said glass capillary tubes and fixing the optical fibers on said body;
said first fixing portion is formed to fix the trunk line side of the optical fibers upon the optical fibers being respectively inserted into said glass capillary tubes;
said second fixing portion has grooves for guiding the optical fibers of the branch line side into said glass capillary tubes respectively;
said second fixing portion is formed so that said branch line side optical fibers are guided into the respective glass capillary tubes through said grooves and then fixed therein with an adhesive after splicing with respective optical fibers on the trunk line side; and
said cover glass is fixed on the body to cover said mount portion and said first and second fixing portions.

2. An optical fiber splice device according to claim 1, which comprises partition walls respectively formed between said guide grooves of said second fixing portion said partition walls preventing an adhesive injected into one groove from flowing into other grooves adjacent thereto.

3. An optical fiber splice device according to claims 1 or 2, wherein said grooves of said second fixing portion are formed with a diameter substantially equal to the diameter of the branch line side optical fibers with the coatings, and wherein each of said grooves has one of a tapered portion and a flared portion guiding a branch line side optical fiber into the glass capillary tube.

4. An optical fiber splice device according to claims 1 or 2, wherein said cover glass is smaller in length than the body and is fixed on the body so that openings are formed at both ends of the body to facilitate the injection of fixing adhesive.

5. An optical fiber splice device according to claims 1 or 2, wherein a transparent plate glass is used for said cover glass and a photo-curing adhesive is used as said fixing adhesive.

6. An optical fiber splice device according to claims 1 or 2, wherein a plurality of branch line side optical fibers are fixed to the body with coatings included.

7. An optical fiber splice device according to claims 1 or 2, wherein said each glass capillary tube has a slot substantially in a middle part thereof for injection a refractive index-matching material.

8. An optical fiber splice device according to claim 7, wherein said refractive index-matching material is injected into said glass capillary tubes in advance of being mounted in the body.

9. An optical fiber splice device according to claims 1 or 2, wherein identification marks are provided at both ends of said body for identifying the first fixing portion of the trunk line side and the second fixing portion of the branch line side.

10. An optical fiber splice device according to claims 1 or 2, which comprises cover members are provided at both sides of the body.
